(19) United States
(12) Patent Application Publication
(10) Pub. No.: US 2007/0136754 A1
(43) Pub. Date: Jun. 14, 2007

(54) Broadcast receiving apparatus and an assisting method for recording program thereof

(75) Inventors: Katsunobu Kimura, Yokohama (JP); Hiroyuki Suzuki, Yokohama (JP)

Correspondence Address: MCDERMOTT WILL & EMERY LLP, 600 13TH STREET, N.W., WASHINGTON, DC, 20005-3096, US

(73) Assignee: Hitachi, Ltd.

(21) Appl. No.: 11/473,082

(22) Filed: Jun. 23, 2006

(30) Foreign Application Priority Data
Dec. 8, 2005 (JP) 2005-354597

(51) Int. Cl. H04N 7/10; H04N 5/445; H04N 7/16; H04N 7/025

(52) U.S. Cl. 725/46; 725/135; 725/34; 725/35

(57) ABSTRACT

A broadcast receiving apparatus, having a function of recording a recommended program, comprises a tuner for receiving program-related information, including broadcasted programs, as well as, planned programs to be broadcasted, a remote controller for inputting a view-operation instruction inputted by a user, and preference information being indicative of a program which the user prefers, a display portion for displaying a broadcasted program received by the tuner, a recommended program information producing portion for extracting a recommended program from the program-related information received, upon basis of the program preference information in putted by the user, and a recording/reproducing device for recoding the broadcasted programs therein, such as, being constructed with a large memory capacity HDD, for example, wherein a picture of the recommended program, which is extracted in the recommended program information producing portion is displayed in a part of the broadcasted program, which is displayed on the large-scale screen, thereby being superior in usability thereof.

### BACKGROUND OF THE INVENTION

The present invention relates to a technology for assisting to make selection/recording/reproducing of broadcast programs from those which are broadcasted through broadcasting, including a digital method and an analogue method therein, and in particular, it relates to a broadcast receiving apparatus suitably displaying the broadcast programs while grasping tendencies in preference of a viewer(s) or audience(s), and a method for assisting to select the program(s) to be recorded.

In recent years, in addition to the television broadcastings of the conventional analog method, there are widely spreading the broadcastings through broadcasting satellites and communication satellites, and further a television broadcasting of a digital method, even in the broadcasting through a terrestrial or ground waves, and also into ordinary families are spreading systems for receiving various kinds of broadcastings. With such the system, comparing to the case of receiving only the conventional analog broadcastings, since it is possible to maintain a large number of channels, programs in a very numerous number thereof are broadcasted, and at the same time, various kinds of audio/video (AV) commercialized appear on the markets one after another. In particular, a television receiver, being such the broadcast receiving apparatus, is remarkable, in recent years, of enlarging screen sizes of the display thereof, representatively, such as, a plasma television adapting a plasma display and/or a liquid crystal television adapting a liquid crystal display therein, for example, as well as it becomes thin in the thickness thereof. Also, at the same time, for the purpose of recording/reproducing of such large number of broadcasting programs as was mentioned above, various kinds of the AV apparatuses are commercialized, such as, a digital VTR, a disk recorder, etc., and most recently is achieved a stream recording/reproducing apparatus, so-called by a “HDD” recorder, building an information recording medium having a large memory capacity therein, such as, a hard disk drive (HDD) or the like, for example, and thereby enabling to receive the large number of channels and to record/reproduce the video-audio stream data with using that HHD therein.

Accompanying with this, as a method for selectively viewing or recording a program at her/his desire from the large number of broadcasting programs, on the other hand, there is already, adopted and widely used a method for selecting a program from a, program chart or guide displayed on a television screen through OSD (On Screen Display), as an EPG (Electronic Program Guide) that is obtained from the EPG information, which is multiplexed on the broadcasting, other than the conventional method for viewing or recording a program selected from a television program guide on a newspaper. With this technology, it is possible to select the program or to set a program for recording with only the television receiver (i.e., the broadcast receiving apparatus), without using the conventional media, such as, the newspapers and/or magazines, for example. Further, in relation with this, as disclosed in the following Patent Documents 1 and 2, for example, various kinds of technologies are proposed and also practically used, for enabling a viewer or audience to select the program, easily, through the operation by means of a remote controller, while displaying a program-related information on the display screen of the television receiver, which is transmitted in addition to the television broadcastings at the same time.

However, with the broadcast receiving apparatus, it is possible to receive the very numerous numbers of programs thereon, due to wide spreading of the digital method television broadcastings as was mentioned above, but because there is a limit in the number of the programs, which can be displayed on the conventional EPG for a user to acknowledge; therefore, it is difficult for the user to find out her/his favorite program therefrom.

Then, as a means for dissolving such the problems, there is already known an apparatus of enabling to present or propose a program or set the timed recording thereof, which is searched out from the programs to be broadcasted within the EPG information mentioned above, i.e., the program of a genre or category, a rating or tendency of audience of which is determined to be high, or the program on which a specific actor/actress appear or takes part, through analyzing the audience tendency: of a viewer or audience upon basis of the EPG information of the programmed, in the following Patent Document 3, for example. Also, there is already known a technology for enabling to propose or recommend a program, which is determined to be near to the interest of the user, much more, through extracting the interest data from a much more large number of equipments, with using a network, for example, in the following Patent Document 4.

Further, an apparatus is already described in the following Patent Document 5, for example, wherein the audience tendency analyzed is displayed on a display in the form of a radar chart, depending on classification of the category or genre thereof, and thereby enabling the viewer or audience to search out a program differing from that displayed in the audience tendency thereof, for example, when she/he wishes to make a change.

[Patent Document 1] Japanese Patent No. 3,601,181 ();

[Patent Document 2] Japanese Patent Laying-Open No. Hei 10-294904 (1998);

[Patent Document 3] Japanese Patent Laying-Open No. 2000-13708 (2000);

[Patent Document 4] Japanese Patent Laying-Open No. 2004-355077 (2004); and

[Patent Document 5] Japanese Patent Laying-Open No. 2004-355429 (2004).

### BRIEF SUMMARY OF THE INVENTION

Thus, with the conventional arts mentioned above, since they use the EPG therein, being the information relating to programs that are scheduled to be broadcasted, and with the programs proposed or recommended to the user, they do not accompany the video and audio as the actual-contents of broadcasting, therefore, the programs sometimes do not agree or fit with the preference or taste of the user, despite of the analysis conducted on the audience tendency of a viewer as was mentioned above. As a result thereof, although conducting the recording thereof, many programs broadcasted are deleted, but without being viewed once. Namely, there is a problem that the programs are automatically recorded even in case where they are not worth to be recorded, in particular.

In addition thereto, with the conventional arts mentioned above, during when the user is viewing a certain program, it is impossible for her/him to seize or know if a favorite program is on the air or not on a competing program, i.e., on channel different from that of said broadcasting. For example, when turning on the television set without the television program guide and watching news by chance, then the user would fail to watch (or cannot record) a drama, on which her/his favorite actor, etc., takes part, even if it is broadcasted on the competing different program. Thus, with this, in spite of the function of recommending or proposing a program, there is still a problem, in particular, in usability thereof.

Then, according to the present invention, accomplished by taking the problems in the conventional arts mentioned above into the consideration thereof, an object thereof is to provide a broadcast receiving apparatus, i.e., comprising a function for receiving broadcasted programs together with the information relating to the programs planned to be broadcasted, so as to extract a program(s) to be recommended to the user, as well as, a recording function (including one comprising the recording apparatus in an outside thereof), thereby being superior in the usability thereof, much more, and also a method for assisting selection of programs to be recorded for it.

For accomplishing the object mentioned above, according to the present invention, there is provided a broadcast receiving apparatus, comprising: a receiver portion for receiving program-related information, including broadcasted programs, as well as, planned programs to be broadcasted therein; an input portion for inputting a view-operation instruction inputted by a user, and preference information being indicative of a program which the user prefers; a display portion for displaying a broadcasted program received by said receiver portion, in accordance with the view-operation instruction from said input portion; an extractor portion for extracting a recommended program from the grogram-related information received by said receiver portion, upon basis of the program preference information of the user, which is inputted through said input portion; and a broadcasted program recorder portion for recording a broadcasted program received by said receiver portion, wherein at least a video of the recommended program broadcasted, which is extracted by said extractor portion, is displayed in apart of the broadcasted program, which is displayed on said display portion.

Further, according to the present invention, in the broadcast receiving apparatus as defined in the above, an audio of the recommended program broadcasted, which is extracted by said extractor portion, may be also outputted by said display means, or said receiver portion may comprise a plural number of tuners. In addition thereto, it is preferable that display is made thereon, including a video of other broadcasted program, which is broadcasted in a time zone same to the broadcasted program displayed on said display portion, as the recommended program on said display portion.

Further, in addition thereto, according to the present invention, for accomplishing the object mentioned above, there is also provided a broadcast receiving apparatus, comprising: a receiver portion for receiving program-related information, including broadcasted programs, as well as, planned programs to be broadcasted therein; an input portion for inputting a view-operation instruction inputted by a user, and preference information being indicative of a program which the user prefers; an output portion for outputting a signal, including a video signal for displaying a broadcasted program received by said receiver portion, in accordance with the view-operation instruction from said input portion; an extractor portion for extracting a recommended program from the grogram-related information received by said receiver portion, upon basis of the program preference information of the user, which is inputted through said input portion; and a broadcasted program recorder portion for recording a broadcasted program received by said receiver portion, wherein at least a video of the recommended program broadcasted, which is extracted by said extractor portion, is outputted through said output portion, or, alternatively, a broadcast receiving apparatus, comprising: a receiver portion for receiving program-related information, including broadcasted programs, as well as, planned programs to be broadcasted therein; an input portion for inputting a view-operation instruction inputted by a user, and preference information being indicative of a program which the user prefers; a display portion for displaying a broadcasted program received by said receiver portion, in accordance with the view-operation instruction from said input portion; and an extractor portion for extracting a recommended program from the grogram-related information received by said receiver portion, upon basis of the program preference information of the user, which is inputted through said input portion, wherein at least a video of the recommended program broadcasted, which is extracted by said extractor portion, is displayed in a part of the broadcasted program, which is displayed on said display portion.

And, according to the present invention, for also accomplishing the object mentioned above, there is further provided an assisting method for assisting to select and display a program to be recorded, in a broadcast receiving apparatus, which can record a broadcasted program received, comprising the following steps of: receiving program-related information , including broadcasted programs, as well as, planned programs to be broadcasted therein; extracting a recommended program from the grogram-related information received, upon basis of a program preference information of a user, which is inputted; and displaying at least a video of the recommended program broadcasted, which is extracted, is displayed in a part of a display portion, as well as, a broadcasted program which is received at present, simultaneously.

Further, according to the present invention, in the assisting method as defined in the above, preferably, a plural number of videos of the recommended programs broadcasted, which are extracted, are displayed in the part of the display portion, as well as, the broadcasted program which is received at present, simultaneously, or the plural number of videos of the recommended programs broadcasted, which are extracted, are displayed in the part of the display portion, exchanging them, one by one.

Also, according to the present invention, in the assisting method as defined in the above, preferably, an audio of the recommended programs broadcasted, which is extracted, is also outputted, and further display is made thereon, including a video of other broadcasted program, which is broadcasted in a time zone same to the broadcasted program displayed on said display portion, as the recommended program on said display portion. And, in such case, preferably, further comprising the step of displaying an inquiry display for asking necessity/unnecessary of recording of the video of other broadcasted program, which is broadcasted in the time zone same to the broadcasted program displayed on said display portion.

### BRIEF DESCRIPTION OF THE DRAWINGS

Those and other objects, features and advantages of the present invention will become more readily apparent from the following detailed description when taken in conjunction with the accompanying drawings wherein:

FIGS. 1(A) to 1(C) are perspective views for showing various modes of the entire structures of a broadcast receiving apparatus, according to an embodiment of the present invention;

FIG. 2 is a block diagram for showing an example of the inner structures of a control box building up the broadcast receiving apparatus mentioned above;

FIG. 3 is a block diagram for showing the detailed structures of a recommended program information producing portion within the control box mentioned above;

FIG. 4 is a view for showing an example of a form for displaying a recommended program on a monitor apparatus, in the broadcast receiving apparatus mentioned above;

FIG. 5 is a view for showing an example of other form for displaying the recommended program on the monitor apparatus, in the broadcast receiving apparatus mentioned above;

FIG. 6 is a view for showing an example of further other form of displaying the recommended program on the monitor apparatus, in the broadcast receiving apparatus mentioned above;

FIG. 7 is a view f or showing an example of a form of displaying recommended programs in a plural number thereof on the monitor apparatus, in the broadcast receiving apparatus mentioned above;

FIG. 8 is a view for showing an example of other form of displaying recommended programs in a plural number thereof on the monitor apparatus, in the broadcast receiving apparatus mentioned above;

FIG. 9 is a flowchart for showing the steps for achieving display of the recommended program(s) about a competing program on a different channel; and

FIG. 10 is a view for showing an example of display of an inquiry, which is displayed within the steps shown in FIG. 9 mentioned above.

### DETAILED DESCRIPTION OF THE PREFERRED EMBODIMENT

Hereinafter, embodiments according to the present invention will be fully explained by referring to the attached drawings.

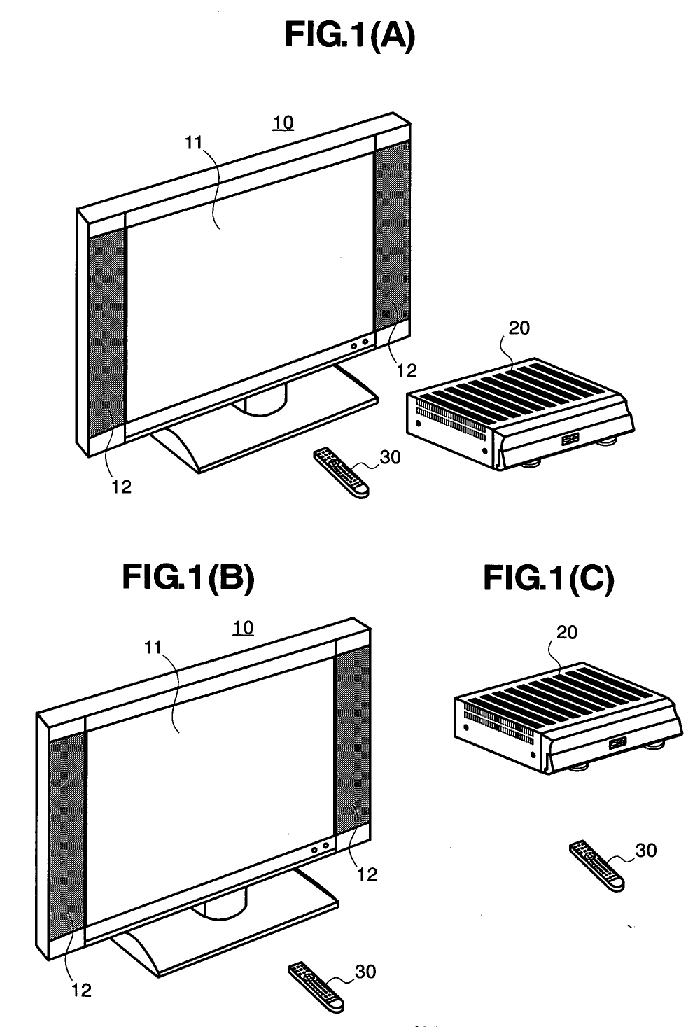

Firstly, FIGS. 1(A) to 1(C) show broadcast receiving apparatuses, according to an embodiment of the present invention, wherein a reference numeral 10 in the figures depicts a monitor device. It is built up with, so-called a flat panel display (FPD), such as, a plasma display panel or a liquid crystal display panel, for example, and has a display screen 11 for displaying an image in a large plane on the surface thereof, and so-called, a pair of speakers 12 and 12 for outputting sounds, on both sides of the display screen 11. Also, a reference numeral 20 in the figure depicts a control box (or a tuner portion), for receiving analog and digital broadcastings, so as to display broadcasted contents thereof (e.g., including a program by means of video/audio, a program on data broadcast or transmission, and data on the data broadcast or transmission) on the monitor device 10 mentioned above. Further, this control box 20 extracts the broadcast program(s) to be recorded, so as to presents it, upon basis of the information relating to the preference or taste of a user, which is inputted through a remote controller, for example, shown by a reference numeral 30 in the figure, and it comprises an information recording device within an inside thereof, thereby enabling to record the broadcast program to be recorded into an inside thereof.

However, in a mode shown in FIG. 1(A), each of the flat panel display (FPD) 10 and the control box 20 mentioned above is constructed into a separated body, respectively (i.e., a separated type), on the other hand FIG. 1(B) shows amode (i.e., an integrated type), wherein those flat panel display (FPD) 10 and control box 20 are built up into one body (for example, the control box 20 is mounted on a rear surface of the flat panel display (FPD) 10, or into a foot portion thereof). Also, further in FIG. 1(C) is shown a mode of only comprising the control box 20, and in such case, a monitor may be attached as an external device thereof.

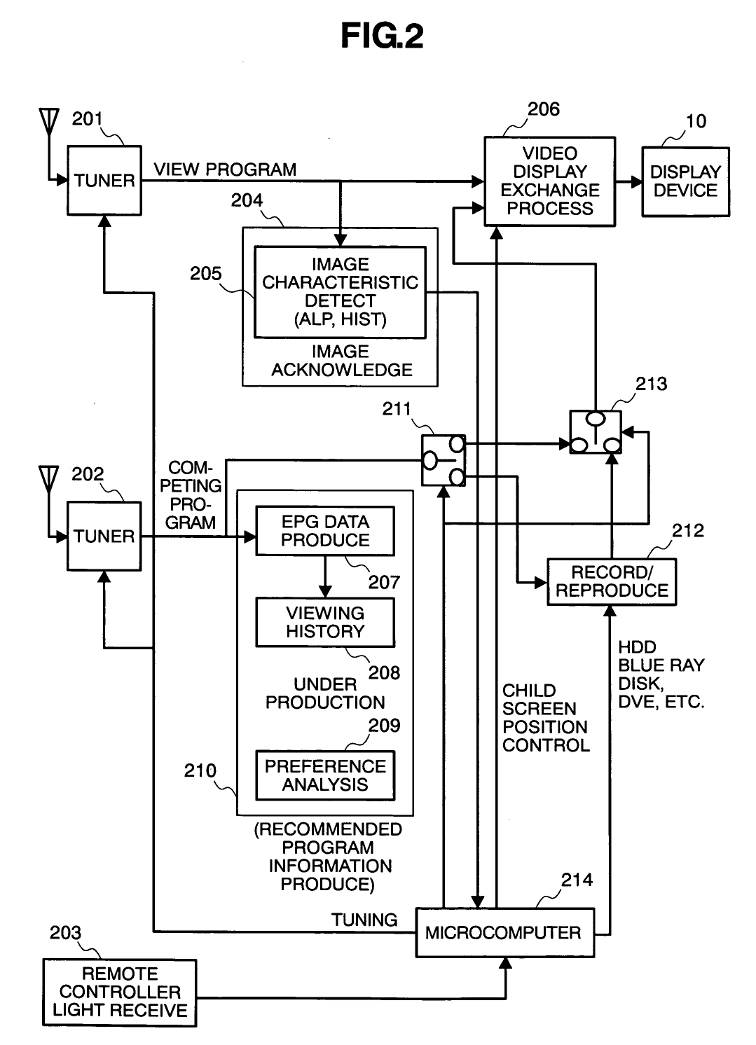

Following to the above, FIG. 2 attached herewith shows the internal structures of the control box 20 mentioned above, and wherein, as is apparent of this figure, it comprises a plural number (in the present embodiment, two (2) pieces) of tuners 201 and 202 for receiving the analog and the digital broadcastings thereon, and further a remote controller light receiving portion 203 for receiving (a light of) a control signal emitted from the remote controller 30 mentioned above, on a front surface of the control box. Further, with the function of those plural numbers of tuners 201 and 202, it is possible to receive both programs, simultaneously; i.e., not only receiving an audience program on a channel to be displayed on the monitor device 10 on one side (for example, the tuner 201), but also receiving the program on other channel (i.e., the competing program) within the same time zone to that of the broadcasting, on the other side thereof (for example, the tuner 202).

Also, within this control box 20, the broadcasted signal (i.e., the program to be viewed) after being demodulated in the tuner 201 is inputted into a video characteristic detector portion 205, a part of which builds up an image confirmation portion 204, and also is outputted into the monitor device 10 of being the separated type or the integrated type, as being an external device, through a video display exchange processing portion 206. On the other hand, although further details of which will be explained later, the broadcasted signal (i.e., the competing program) after being demodulated in the tuner 202 is inputted into a recommended program information producing portion 210, which comprises an EPG data producing portion 207, a viewing history processor portion 208, a taste analyzer portion 209, etc., as is shown in the figure, and it is also outputted into a recording/reproducing device 212, which is built up with a hard disk drive (i.e., the HDD) of a large memory capacity, for example, and is provided within an inside of the apparatus, through an exchange switch 211. Or, it may be outputted also into the monitor device 10, through other exchanger switch 213, in addition to the exchange switch 211 mentioned above and further the video display exchange processing portion 206 mentioned above. However, this recording/reproducing device 212 should not be restricted only to such the hard disk drive (i.e., the HDD) of large memory capacity as was mentioned above, however in the place thereof, it may be constructed with a Blue ray Disk device, a DVD device, etc., for example. Or alternatively, this recording/reproducing device 212 may be provided, not only within an inside of the apparatus, but also in an outside of the said apparatus. However, is such case, the broadcasted signal may be outputted through an external output terminal not shown in the figure.

In addition thereto, within this control box 20 is provided a controller portion, which is constructed with a microcomputer 214, for example. As is shown in the figure, into this microcomputer 214 are inputted at least signals from the remote controller light receiving portion 203 and the video characteristic detector portion 205 of the image confirmation portion 204, and at the same time, control signals thereof are outputted to, at least the plural number of tuners 201 and 202, the exchanger switches 211 and 213, the video display exchange processing portion 206, and further the recording/reproducing device 212, which are mentioned above. Thus, this microcomputer 214 controls operations including tunings within the plural number of tuners 201 and 202, and also the exchange operations of the exchanger switches 211 and 213. Further, this microcomputer 214 controls the position where a child screen be displayed on the monitor device 10, such as, of the competing program received by the tuner 202, or the like, for example, through the video display exchange processing portion 206. Moreover, this microcomputer 214 also controls recording/reproducing operations of the recording/reproducing device 212 mentioned above.

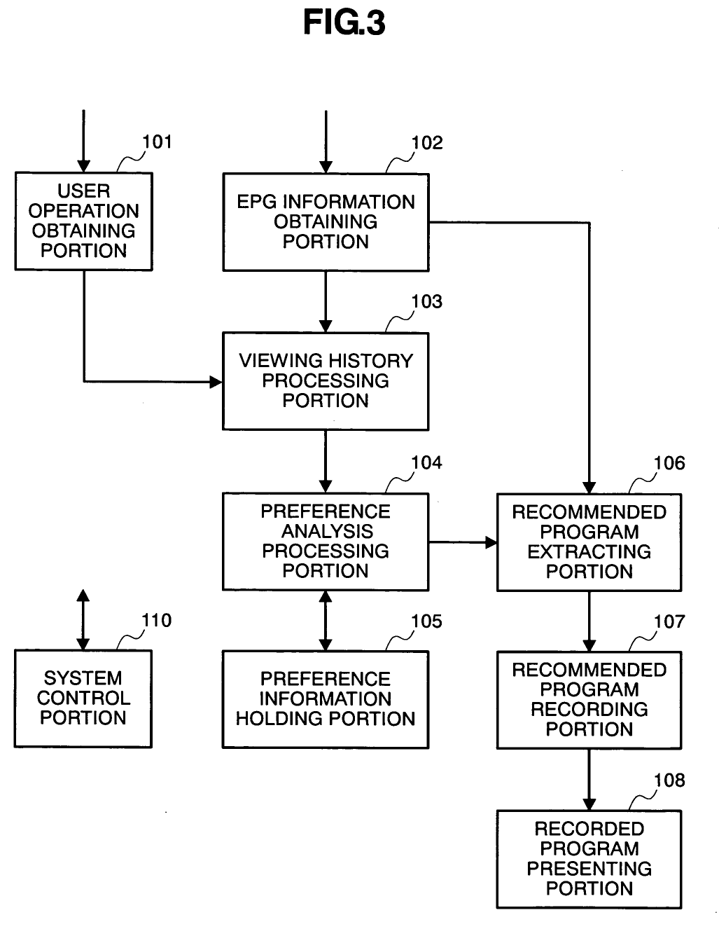

Next, explanation will be give on the detailed structures of the recommended program information producing portion 210 explained in the above, by referring to the block diagram shown in FIG. 3 attached herewith.

In this FIG. 3, a reference numeral 101 depicts a user operation obtaining portion, which obtains operation information made by a user, through the above-mentioned remote controller 30 or the like, so as to process it therein. Within an EPG information obtaining portion 102 is obtained from the program information for one (1) week transmitted, being multiplexed with the broadcasted programs, program information, such as, a program name, a genre or category, and an actor/actress taking part thereof, etc., which are contained in that information, for example, in case of the digital broadcasting. However, this EPG information may be obtained with using the Internet, for example, in the place of that mentioned above. A viewing history processing portion 103 extracts the channel and the category of the program to be viewed, and keywords, such as, a program name, a name of an actor/actress taking part and/or a noun, etc., i.e., the program characteristic information, together with data of the actual time of viewing, upon basis of the operation made for program viewing, which is obtained in the user operation obtaining portion 101, and also the program information obtained in the EPG information obtaining portion 102 mentioned above.

Next, in a preference analysis processing portion 104, determination/extraction is made on the program characteristic information being high in tendencies of the preference or taste, which the user views very often, by using the tendency of preference or taste up to the present, which is held in a preference information holding portion 105, for example, and analysis is made on a preference degree (i.e., a degree of the preference or taste of the user), in relation to the category or genre and/or the keywords of that program characteristic information extracted. And then, preference information is produced, which is constructed with the category and the keywords, etc., and also the preference degree referred thereto. As a process for preference analysis within the preference analysis processing portion 104 may be used a fuggy logic (or a fuggy syllogism), for example, and thereby producing new preference information, with the program characteristic information of that program and also the past preference information if any is included in that program characteristic information, by adding various information thereto, such as, if viewing is made from a beginning to an end on a certain program, how much degree viewing is made on a certain program during an entire time period thereof, or if the program is one that is exchanged in tuning on the way of viewing thereof, etc., for example. However, as the input factors to be applied into the processing of the preference analysis within the preference analysis processing portion 104, there may be applied arbitrary ones other than those mentioned above, and also as a method to be applied in this preference analysis processing portion 104 may be a neural network logic or theory, the genetic algorithm, the chaos theory, the leaning theory, etc., other than the fuzzy logic mentioned above. Also, in this figure, a reference numeral 105 depicts a preference information holding portion, which renews/holds the preference information analyzed/produced within the preference analysis processing portion 104, or hold it newly, therein.

Further, a reference numeral 106 in the figure depicts a recommended program extracting portion, and it extracts the program, the program characteristic information of which conform with the information being high in the degree of preference (for example, the information, such as, the category and the keywords, etc.), from the program information obtained within the EPG information obtaining portion 102 mentioned above, with using the preference information from the preference analysis processing portion 104 mentioned above, and it delivers the conforming program to a recommended program recording portion 107, as a recommended program. And, this recommended program recording portion 107 records all of video signals and audio signals of the program corresponding thereto, principally, from the program information delivered from the recommended program extracting portion 106 mentioned above, automatically, into the hard disk drive (i.e., the HDD) of large memory capacity, being the recording/reproducing device 212 provided within an inside of the apparatus, for example. However, for example, in the case where the time zone of the program, which the user sets the timed recording, overlaps on the time zone when the program recommended is broadcasted, it is also possible to execute the timed recording by a user set program recording portion not shown in the figure, by taking preference thereto. However, when recording of the video signals into this recording/reproducing device 212, it is preferable to compress them to be in the digital signals by apply a MPEG encoder and a MPEG recorder therein.

Also, a reference numeral 108 in the figure depicts a recorded program presenting portion for presenting the programs recoded, for example, in the form of a list or the like, and together with the picture of that program recorded, it presents a recording data, a channel, a program name, etc., and also the category and the keywords at the same time, as the preference information to be a reason for recommendation thereof. And, a reference numeral 110 in the figure depicts a system control portion, for controlling various portion of the recording/reproducing device, including other processing system for receiving the digital broadcast, not shown in the figure, and this may be also shared with the microcomputer 214 shown in FIG. 2 mentioned above, in common.

Next, explanation will be made below, about the operations of the recommended program information producing portion 210, the detailed structures of which was shown in the above. First of all, the user operation obtaining portion 101 obtains the operation information of, such as, tuning and/or EPG display, which are conducted by the user through the remote controller, for example. The operation information obtained relates to the program viewing, such as, the tuning, for example, and then the user operation obtaining portion 101 informs that operation information to the viewing history processing portion 103. Also, the EPG information obtaining portion 102 obtains the EPG information multiplexed with the program contents, in case of the digital broadcasting, for example. This EPG information includes a starting time and a length of program, a program name, an explanation of the program contents, names of actors/actresses taking part thereof, and a category or genre, etc., for each of the programs, therein, and it includes the information up to eight days earlier including that of that day.

Upon receipt of the operation information relating to the program viewing from the user operation obtaining portion 101, the viewing history processing portion 103 obtains the program information of that program, on which viewing is made at present, from the EPG information obtaining portion 102. The viewing history processing portion 103 produces so-called a view history information, i.e., being constructed with the program name of the program, the category and the keywords thereof, such as, the name of actor/actress and nouns, which are included in the program name and/or the explanation of the program contents, and the actual time of viewing that program, and it notices this to the preference analysis processing portion 104.

This preference analysis processing portion 104 analyzes the preference degree (i.e., the degree of preference or taste of the user) in relation to the category and/or the keywords within the extracted program characteristic information, with using the viewing history information (i.e., the program characteristic information, such as the category and the keywords, and the actual time of viewing), which is noticed from the viewing history processing portion 103, and the preference information extracted from the tendencies of preference up to the present held within the preference information holding portion 105, and thereby also analyzing on the tendency of preference of the user, i.e., the program in which category or keywords she/he views, preferably, etc. In this manner, analysis is made on the degree of preference in relation to the category and the keywords, etc., from the new viewing history, while reflecting the degree of preference upon it, and from a result of the analysis, a new degree of preference is calculated out, in relation to the category and the keywords, etc., and thereby producing new preference information, which is made from the category and the keywords, etc., together with a degree of preference corresponding thereto.

However, this new preference information is noticed to the preference information holding portion 105, and the said preference information holding portion 105 renews/holds the preference information noticed from the preference analysis processing portion 104, or holds it newly, therein. And, the preference analysis processing portion 104 notices the information, such as, the category and the keywords, etc., of the preference information, which is high in the degree of preference, to the recommended program extracting portion 106.

Also, the recommended program extracting portion 106 searches out a program in conformity with the information of high preference degree (i.e., the information, such as, the category and the keywords), which that user prefers, among the program information obtained within the EPG information obtaining portion 102, upon basis of the preference information that the user prefers, which is noticed from the preference analysis processing portion 104, and it notices it to the recommended program recording portion 107 as a recommended program.

At the same time when conducting the timed recording of the program noticed, this recommended program recording portion 107 also records the program, including the preference information therein (i.e., the information, such as, the category and the keywords, etc.), as recommendation information thereof, by referring to the program. However, when conducting the timed recording of this program noticed, the recording is made on the video signals and the audio signals thereof, included therein. Thereafter, the recorded program presenting portion 108 displays the programs, which are recorded within the recommended program recording portion 107, on the monitor device 10, by at least the picture thereof, or including character information in a part thereof.

Following to the above, explanation will be given on modes of displaying the programs, which are recorded by the recommended program recording portion 107, on a large-scaled screen of the plasma display panel or the liquid crystal display panel, for example, within the broadcast receiving apparatus, the structures of which are explained in the above.

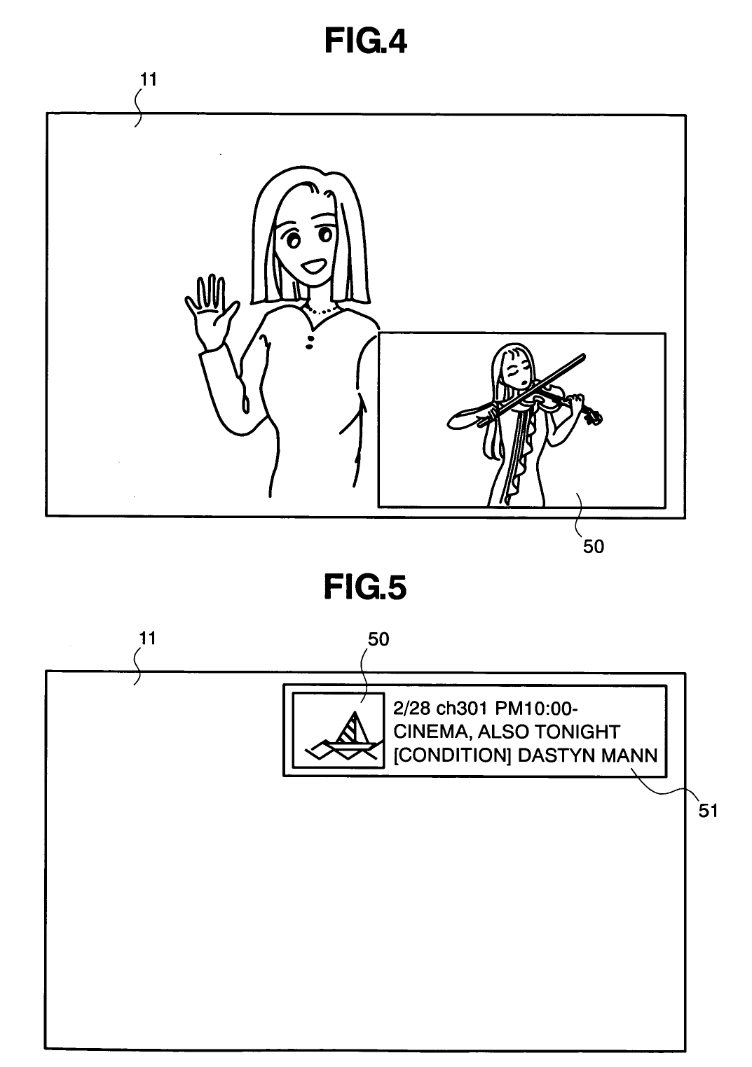

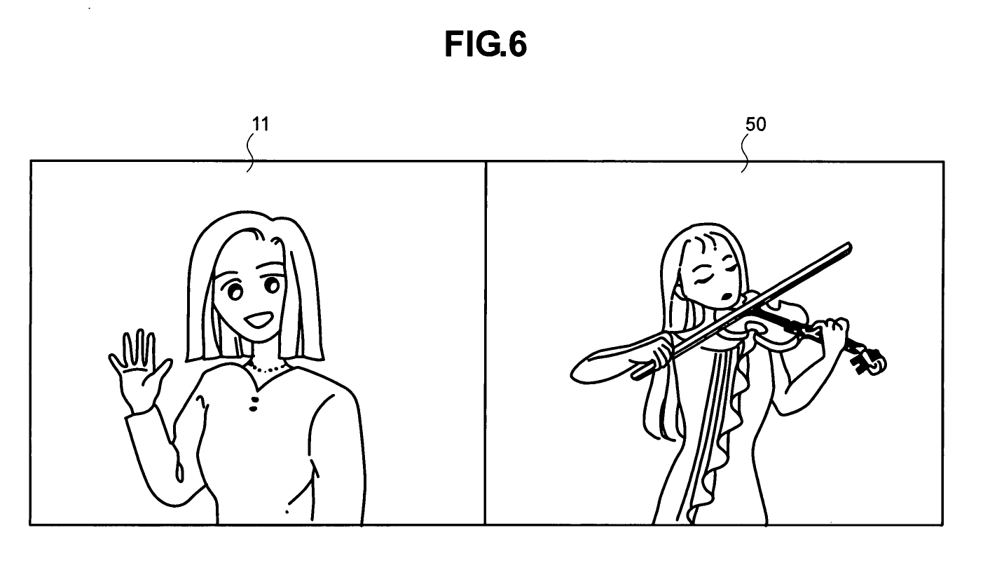

First of all, in FIG. 4 attached herewith, upon the display screen (i.e., a main screen) of the monitor device 10 are displayed a broadcast program, which is received at present (i.e., the viewing program), and also a program recorded by means of the recommended program recording portion 107, i.e., a picture 50 of the recommended program, in a part thereof (in this example, at a lower-right corner on the screen). With such the display mode of the recommended programs, it is possible to confirm the program to be recorded, in the form of the picture 50, actually. With doing this, for the user, it is possible to acknowledge on what kind of the program recommended is, concretely, so that she/he can determine on whether it is the program that she/he wishes to view by recording thereof, easily and with certainty. However, display of the picture 50 of such the recommended program may be made on other portion on the display screen 11, in the place of that mentioned above, such as, at a lower left corner on the screen, at a upper right corner (see FIG. 5), or at a upper left corner, for example. In addition thereto, in this case, while detecting a background portion of the screen displayed on the main screen 11 through an ordinary picture processing, for example, it is also possible to display the picture of the recommended program at that portion corresponding thereto. Or, it is also possible to display the picture 50 of the recommended program, but escaping from a portion of a face of a person displayed, on the main screen 11, by avoiding the portion of a skin-color thereon, for example. Or, it is also possible to display it by selecting a portion low in the brightness thereof, such as, a black color, for example. Or, dividing the display screen equally into two (2) portions, as is shown in FIG. 6, it is possible to display the main screen in one of them, while displaying the picture of the recommended program on the other.

Next, as is shown in FIG. 5 attached herewith, it is also possible to display the picture 50 of the recommended program mentioned above, as well as, the recoding date/time and a channel number thereof, and further the program name and the actor/actress taking part therein, together with the character information recorded in relation to the program, within a predetermined frame 51. However, with such the display mode, it is possible to present, not only the recording data/time, the channel and the program name, but also the preference information, such as, the category and the keywords, etc., which comes to be the recommendation information when setting the timed recording of the program recoded by referring thereto, at the same time; therefore, for the user, it is also possible to acknowledge what the recommended information is, and to determine on whether it is the program or not, which she/he wishes to view, easily.

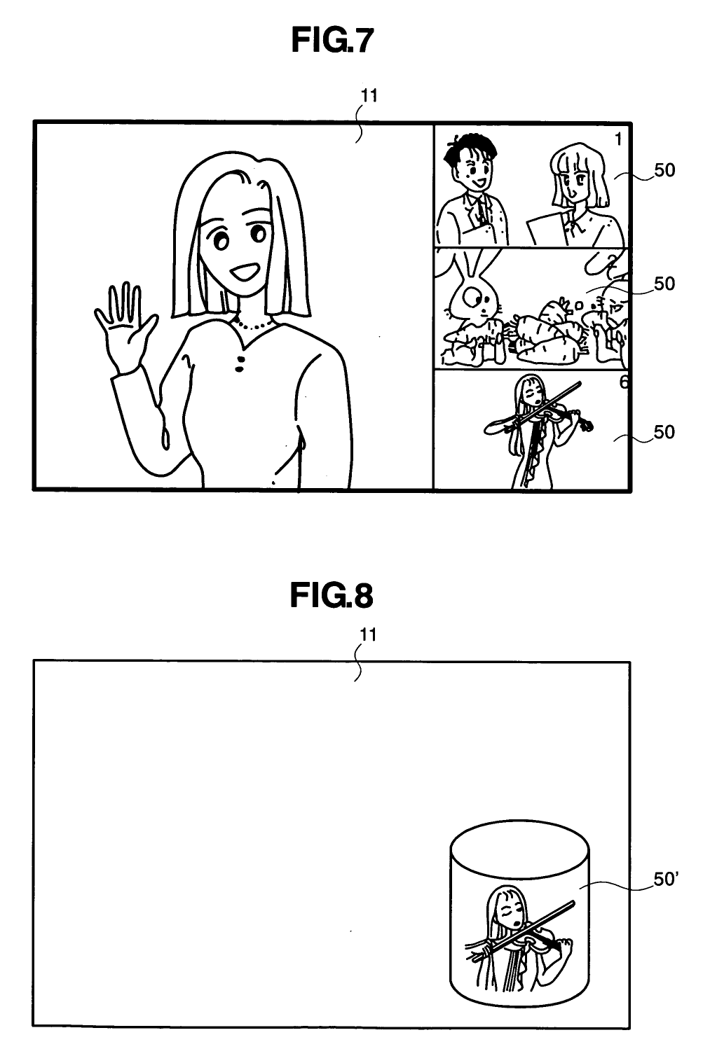

Also, the mode for displaying the program is shown in FIGS. 7 and 8 attached herewith, in particular, in case where there are pictures 50 of the recommended programs in plural numbers thereof.

Thus, in FIG. 7, frames are provided in plural numbers thereof at the left-hand side on the display screen (i.e., the main screen) 11 of the monitor device 10, so as to display plural numbers of the pictures 50, 50 . . . of the recommended programs within each inside thereof. However, the frames for displaying the pictures 50, 50 . . . of the plural numbers of recommended programs therein may be provided other than the above-mentioned, for example, at the left-hand side of the display screen (i.e., the main screen) 11, or the upper or lower end thereof.

On the other hand, in the mode shown in FIG. 8, for example, a column 50′(or may be a pillar having a polygonal cross-section) is displayed at the lower right corner on the display screen (i.e., the main screen) 11 of the monitor device 10, wherein the pictures 50, 50 . . . of the corresponding plural numbers of the recommended programs are shown, sequentially, on the surface (i.e., a front surface) thereof, while scrolling the column into the direction of an arrow (please see the arrow shown in the figure), for example. However, with this, in spite of the plural numbers of the pictures of recommended programs, it is enough to display only one (1) pieces of the column (or the pillar) on the display screen (i.e., the main screen) 11, and for this reason, the plural numbers of the pictures of recommended programs will not disturb on the main screen. This may be a preferable method, in case where there are pictures of the recommended programs in a large number thereof, in particular. Also, scrolling of the pictures of recommended programs mentioned above may be made manually (for example, by using a scroll key of the remote controller 39), or automatically (for example, by rotating the column in the arrow direction, at ever time period predetermined). Further, ranking the plural numbers of recommended programs, display may be made on the picture thereof in the order of the said ranking (for example, a first one, a second one, a third one . . . ), sequentially. Moreover, the column or the polygonal pillar mentioned above may be disposed, directing the axis thereof into the vertical direction, as is shown in the figure, or directing it into the horizontal direction, though not shown in the figure. In addition thereto, in the place of the column or the polygonal pillar, display may be made on the surface of a sphere.

Although mentioning was made that the display of picture(s) of the recommended program(s) be made on the display screen 11 of the monitor device 10, in the explanation mentioned above, however it should not be restricted to that, according to the present invention, and therefore, for example, the recommended program(s) may be outputted through the speakers 12 and 12, which build up the monitor device 10 mentioned above, together with the picture(s) thereof. But, in such case, it is preferable to set a sound volume thereof to be smaller than that of the main screen.

Also in the above explanation, as was shown in FIG. 2 mentioned above, it is said that the plural numbers (in the present example, two (2) pieces) of tuners 201 and 201 are provided within an inside of the control box 20, which builds up the broadcast receiving apparatus according to the present invention. However, not restricted to that, but of course, those tuners can be provided in a number of pieces more than two (2), and further it is possible to provide only one (1) piece of the tuner, in the structures. In particular, when providing only one piece of the tuner, it is possible to achieve the display of the pictures 50, 50 . . . of the recommended programs on the display screen (i.e., the main screen) 11 mentioned above, by displaying a moving picture thereof while exchanging it at a high speed, among the plural numbers of programs broadcasted, or displaying a still picture while exchanging it among pictures memorized in a memory.

By the way, in the detailed explanation given in the above, explanation was made that the picture 50 displayed on the display screen (i.e., the main screen) of the monitor device 10 is selected/extracted in advance, by means of the recommended program information producing portion 210 explained in the above, and that it is recorded onto the hard disk drive (HDD) of large memory capacity, i.e., the recording/reproducing device 212 provided within the apparatus. However, as was already mentioned above, with the conventional technologies, when displaying a certain broadcasting program on the monitor device 10, for example, then it is impossible to grasp the video contents of the broadcastings other than that program, i.e., of the competing programs broadcasted on other channels, and therefore there occurs a problem of deteriorating the usability thereof. Then, according to the present invention, for dissolving also such the problem, in particular, with the competing program(s), it is displayed in a manner or method, which will be explained below, as a recommended program. With this, for a user, who is watching on news, occasionally, after turning the television ON, but without making a check on the television guide, for example, it is impossible to loose a chance to enjoy (or to record) a dram, in which her/his favorite actor/actress or the like takes part, even if it is broadcasted on the competing program.

However, as is apparent from the detailed explanation mentioned above, with the broadcast receiving apparatus according to the present invention, in case where the monitor device 10 is OFF, the recommended programs selected/extracted by means of the recommended program information producing portion 210 are recorded onto the hard disk drive (HDD) of large memory capacity, i.e., the recording/reproducing device 212 provided win the apparatus. However, even in the cases where the monitor device 10 is ON (i.e., when the user watching on the TV), there occurs a case where the recommended program(s) is/are selected/extracted by the recommended program information producing portion 210.

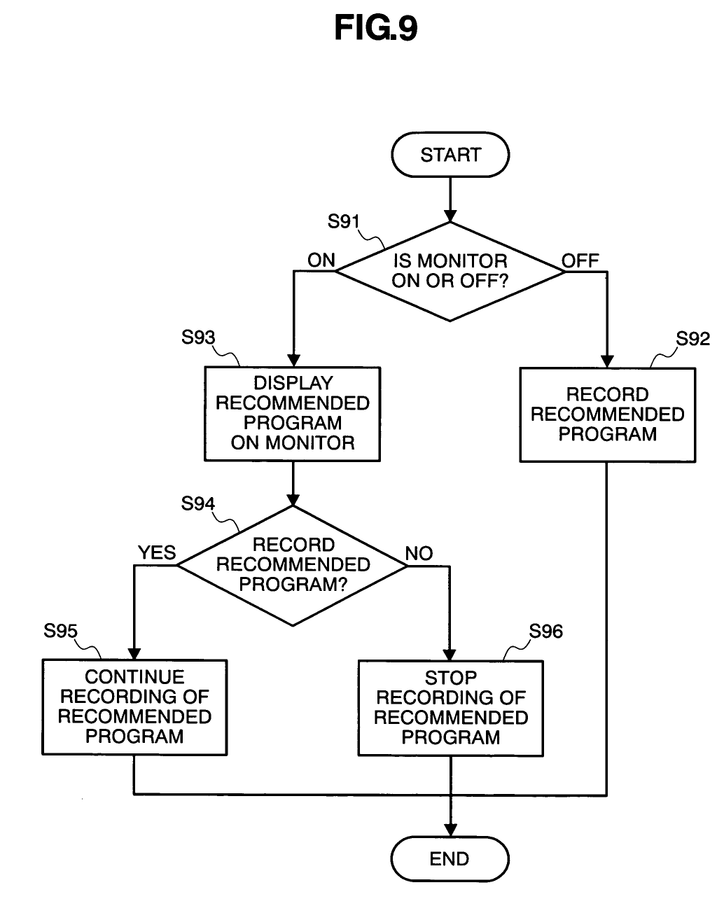

Then, within the control box 20 shown in FIG. 2 mentioned above, by the function of the microcomputer 214 building up the controller portion thereof, the recommended program(s) selected/extracted by the recommended program information producing portion 210, as well as, being recorded onto the hard disk drive (HDD) of large memory capacity, i.e., the recording/reproducing device 212, is conducted with the processes shown in FIG. 9. Thus, the processes are started when the recommended program is selected/extracted by the recommended program information producing portion 210, and firstly, it is determined in which condition the monitor device 10 is, i.e., ON or OFF (S91). As a result, if the monitor device 10 is OFF in the condition thereof, then the broadcast receiving apparatus determines that the user does not watch or view the broadcasted program thereon, and automatically, it records the video and audio of the said recommended program onto the hard disk drive (HDD) of large memory capacity (S92), thereby completing the processes.

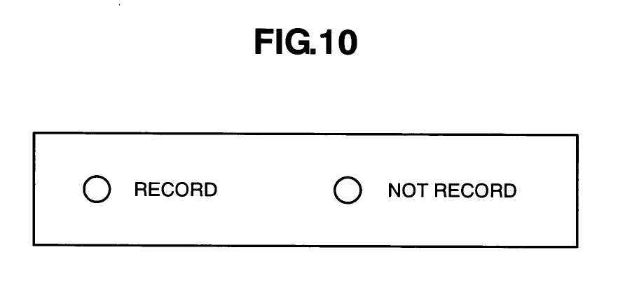

On the other hand, if determining that the monitor device 10 is ON condition in the determining process (S91) mentioned above, determination is made that the user is now watching or viewing the broadcasted program thereon, and the said recommended program is displayed in a part on the display screen (i.e., the main screen) 11 of the monitor device 10 (S93). However, in this instance, as well as, recording of the video and audio of said recommended program is started onto the hard disk drive (HDD) of large memory capacity, as was mentioned above, and at the same time, also a display of an inquiry is made, as shown in FIG. 10, for example. Thus, with doing this, even when the recommended program is selected/extracted among the competing programs on the on the channel different from that, the user can confirm the contents thereof, through the picture thereof, with certainty.

Following to the above, determination is executed if the recommended program displayed on the monitor device 10 should be recorded or not (S94). Thus, with doing this, as a result of confirmation of the contents of that competing program through the picture thereof, the user can select “RECORD” when she/he decides the recording is necessary, or “NOT RECORD” on the other hand when she/he decides the recording in unnecessary, on the inquiry screen shown in FIG. 10. The necessity or unnecessary of recording is selectable for the user, by moving the position of a cursor (i.e., an arrow), which is displayed on the screen, with use of the remote controller 30 mentioned above. And, as a result of the determination (S94), if determination is made to record (i.e., “YES”), then the recording onto the hard disk drive (HDD) of large memory capacity is continued, and thereby completing the recording of the video and audio of that competing program (S95). On the other hand, if determination is made not to record (i.e., “NO”), then the recording is stopped on the video and audio of that competing program (S96), and thereby completing a series of the processes.

In the above description, although explanation was made that the control box (or, the tuner potions) 20 of the broadcast receiving apparatus mentioned above achieves the record of programs, i.e., the broadcasted programs to be recorded, by means of the information recording device 212 built up with the hard disk drive (HDD) of large memory capacity, which is installed within an inside thereof, however the present invention should not be restricted to that, but the information reproducing apparatus mentioned above may be provided or attached on an outside of said apparatus.

As was fully explained in the above, according to the present invention, it is possible to obtain an effect being practically superior, i.e., there can be provided the broadcast receiving apparatus having a function of enabling to extract a recommended program(s) to be recorded, so as to present it/them to a user, wherein the user can view a picture(s) of the program(s) to be recorded, actually, thereby being superior in usability thereof, and the method for it, i.e., for assisting to select and display the program(s) to be recorded, as well.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A broadcast receiving apparatus, comprising:
a receiver portion which receives program-related information, including broadcasted programs, as well as, planned programs to be broadcasted therein;
an input portion which inputs a view-operation instruction inputted by a user, and preference information being indicative of a program which the user prefers;
a display portion which displays a broadcasted program received by said receiver portion, in accordance with the view-operation instruction from said input portion;
an extractor portion which extracts a recommended program from the grogram-related information received by said receiver portion, upon basis of the program preference information of the user, which is inputted through said input portion; and
a broadcasted program recorder portion which records a broadcasted program received by said receiver portion, wherein
at least a video of the recommended program broadcasted, which is extracted by said extractor portion, is displayed in a part of the broadcasted program, which is displayed on said display portion.

2. The broadcast receiving apparatus, as defined in the claim 1, wherein an audio of the recommended program broadcasted, which is extracted by said extractor portion, is also outputted by said display means.

3. The broadcast receiving apparatus, as defined in the claim 1, wherein said receiver portion comprises a plural number of tuners.

4. The broadcast receiving apparatus, as defined in the claim 1, wherein display is made thereon, including a video of other broadcasted program, which is broadcasted in a time zone same to the broadcasted program displayed on said display portion, as the recommended program on said display portion.

5. A broadcast receiving apparatus, comprising:
a receiver portion which receives program-related information, including broadcasted programs, as well as, planned programs to be broadcasted therein;
an input portion which inputs a view-operation instruction inputted by a user, and preference information being indicative of a program which the user prefers;
an output portion which outputs a signal, including a video signal for displaying a broadcasted program received by, said receiver portion, in accordance with the view-operation instruction from said input portion;
an extractor portion which extracts a recommended program from the grogram-related information received by said receiver portion, upon basis of the program preference information of the user, which is inputted through said input portion; and
a broadcasted program recorder portion which records a broadcasted program received by said receiver portion, wherein
at least a video of the recommended program broadcasted, which is extracted by said extractor portion, is outputted through said output portion.

6. A broadcast receiving apparatus, comprising:
a receiver portion which receives program-related information, including broadcasted programs, as well as, planned programs to be broadcasted therein;
an input portion which inputs a view-operation instruction inputted by a user, and preference information being indicative of a program which the user prefers;
a display portion which displays a broadcasted program received by said receiver portion, in accordance with the view-operation instruction from said input portion; and
an extractor portion which extracts a recommended program from the grogram-related information received by said receiver portion, upon basis of the program preference information of the user, which is inputted through said input portion, wherein
at least a video of the recommended program broadcasted, which is extracted by said extractor portion, is displayed in a part of the broadcasted program, which is displayed on said display portion.

7. An assisting method for assisting to select and display a program to be recorded, in a broadcast receiving apparatus, which can record a broadcasted program received, comprising the following steps of:
receiving program-related information, including broadcasted programs, as well as, planned programs to be broadcasted therein;
extracting a recommended program from the grogram-related information received, upon basis of a program preference information of a user, which is inputted; and
displaying at least a video of the recommended program broadcasted, which is extracted, is displayed in a part of a display portion, as well as, a broadcasted program which is received at present, simultaneously.

8. The assisting method, as defined in the claim 7, wherein a plural number of videos of the recommended programs broadcasted, which are extracted, are displayed in the part of the display portion, as well as, the broadcasted program which is received at present, simultaneously.

9. The assisting method, as defined in the claim 8, wherein the plural number of videos of the recommended programs broadcasted, which are extracted, are displayed in the part of the display portion, exchanging them, one by one.

10. The assisting method, as defined in the claim 7, wherein an audio of the recommended programs broadcasted, which is extracted, is also outputted.

11. The assisting method, as defined in the claim 7, wherein display is made thereon, including a video of other broadcasted program, which is broadcasted in a time zone same to the broadcasted program displayed on said display portion, as the recommended program on said display portion.

12. The assisting method, as defined in the claim 11, further comprising the step of displaying an inquiry display for asking necessity/unnecessary of recording of the video of other broadcasted program, which is broadcasted in the time zone same to the broadcasted program displayed on said display portion.
